(19) United States
(12) Patent Application Publication
(10) Pub. No.: US 2008/0222721 A1
(43) Pub. Date: Sep. 11, 2008

(54) DIGITAL MULTIPLE APPARATUS

(75) Inventor: Mitsuhiro Kinoshita, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/681,878

(22) Filed: Mar. 5, 2007

(51) Int. Cl. H04L 9/32

(52) U.S. Cl. 726/21

(57) ABSTRACT

Authentication data is read when a digital multiple apparatus main body starts, it is authenticated whether the authentication data read is regular authentication data, a printing operation is permitted if the authentication data read is the regular authentication data, and print data is printed with information on at least the authentication data and date and time information of printing added to the print data.

### BACKGROUND OF THE INVENTION

1. Field of the Invention

The present invention relates to, for example a digital multiple apparatus having functions for printing and copying of print data.

2. Description of the Related Art

In recent years, there is a rapidly growing interest in security of information. Amid such a growing interest in security, there is an increasing interest in security of information for digital multiple apparatuses. Under such circumstances, a digital multiple apparatus having an access limiting function is commercialized. This access limiting function limits, using, for example, a password or user authentication, users allowed to use the digital multiple apparatus.

As a technique concerning security of an image forming apparatus, there is JP-A-2001-320568. This JP-A-2001-320568 discloses that the image forming apparatus includes receiving means for receiving image information including first identification information for identifying a user, acquiring means for acquiring second identification information for identifying a user, comparing means for comparing the first identification information and the second identification information, and superimposing means for superimposing, when the users indicated by the first identification information and the second identification information coincide with each other according to this comparing means, information indicating the user on image information as electronic watermark data.

### BRIEF SUMMARY OF THE INVENTION

A digital multiple apparatus according to a main aspect of the invention includes a recording unit that prints print data, an authentication-data reading unit that reads authentication data, an authenticating unit that authenticates whether the authentication data read by the authentication-data reading unit is regular authentication data, and an operation executing unit that permits a printing operation by the recording unit if the authentication data read by the authentication-data reading unit is the regular authentication data as a result of the authentication by the authenticating unit and prints the print data using the recording unit with information on at least the authentication data and date and time information of printing added to the print data.

A storage medium having stored therein an authentication program for a digital multiple apparatus according to a main aspect of the invention includes reading authentication data when a digital multiple apparatus main body starts and authenticating whether the authentication data read is regular authentication data, and permitting a printing operation if the authentication data read is the regular authentication data as a result of the authentication and printing print data with information on at least the authentication data and date and time information of printing added to the print data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a first embodiment of a digital multiple apparatus according to the invention;

FIG. 2 is a functional block diagram of a CPU in the apparatus;

FIG. 3 is a digital multiple operation flowchart at the time of printing in the apparatus;

FIG. 4 is a diagram showing print data, a user ID number, and date and time information of printing printed on a recording medium;

FIG. 5 is a diagram showing print data, a user ID number, and date and time information of printing printed at another date and time;

FIG. 6 is a digital multiple operation flowchart at the time of copying in the apparatus;

FIG. 7 is a diagram showing print data, a user ID number, and date and time information of copying copied at the time of copying; and

FIG. 8 is a diagram showing print data, a user ID number, and date and time information of copying copied at the time of copying at another date and time.

### DETAILED DESCRIPTION OF THE INVENTION

An embodiment of the invention will be hereinafter explained with reference to the drawings.

FIG. 1 shows a diagram of a digital multiple apparatus. A digital multiple apparatus main body 1 includes a CPU (Central Processing Unit) 2 that constitutes a control unit main body. A ROM (Read Only Memory) 4, a RAM (Random Access Memory) 5, a key input unit 6, a card reader 7, an original scanning unit 8, an image-data storing unit 9, a liquid-crystal display unit 10, a recording unit 11, and a LAN (Local Area Network) control unit 12 are connected to the CPU 2 via a bus 3.

A digital multiple operation program in the digital multiple apparatus main body 1 is stored in the ROM 4. This digital multiple operation program causes the digital multiple apparatus main body 1 to perform, for example, a printing operation or copying operation for print data. The print data includes image data and characters such as letters.

An authentication program for the digital multiple apparatus main body 1 is stored in the ROM 4. In printing print data, when the digital multiple apparatus main body 1 starts, this authentication program reads authentication data with a card reader 7 and authenticates whether this authentication data read is regular authentication data. If the authentication data read is regular authentication data as a result of the authentication, the authentication program permits a printing operation by the recording unit 11 and prints the print data with information on at least the authentication data and date and time information of printing added to the print data.

In performing copying, the authentication program reads authentication data with the card reader 7 and authenticates whether this authentication data read is regular authentication data. If the authentication data read is the regular authentication data as a result of the authentication, the authentication program permits a copying operation by the original scanning unit 8 and the recording unit 11 and performs a copying operation with information on at least the authentication data and date and time information of copying added to print data.

Control data at the time of operations of the key input unit 6, the card reader 7, the original scanning unit 8, the image-data storing unit 9, the liquid-crystal display unit 10, the recording unit 11, and the LAN control unit 12 are stored in the RAM 5.

The key input unit 6 includes various buttons for operating the digital multiple apparatus main body 1. The key input unit 6 includes plural keys for inputting, for example, authentication data given to a user in advance, for example, an ID (identity card) number.

ID numbers different from one another are given to plural users in advance. The users carry, for example, ID cards 13, respectively. Authentication data given to the users, respectively, i.e., user ID numbers are registered in these ID cards 13. The ID cards 13 are used as, for example, employee identification cards of companies.

The card reader 7 reads, for example, the user ID numbers given to the users, which are registered in the ID card 13. Regular user ID numbers given to the users are registered in the card reader 7 in advance. The regular user ID numbers are registered not only in a memory in the card reader 7. For example, a database for authentication 5a is formed in the RAM 5. The regular user ID numbers given to the users may be registered in this database for authentication 5a in advance. The database for authentication 5a is explained as being formed in the RAM 5. However, the database for authentication 5a is formed not only in the RAM 5 and may be formed in, for example, a RAM or the like of a client PC 16. It is possible to add, change, and delete the regular user ID numbers registered in the database for authentication 5a.

The regular user ID numbers indicate, for example, users who are permitted to perform a printing operation and a copying operation for print data in the digital multiple apparatus main body 1. Therefore, the card reader 7 authenticates whether a user ID number read is a regular user ID number. The authentication of whether a user ID number read is a regular user ID number may be executed according to arithmetic processing by the CPU 2.

The original scanning unit 8 scans an original to be copied in which characters such as letters and images are recorded and outputs scanning data of the original. The original scanning unit 8 operates, for example, at the time of copying of the original to be copied (hereinafter referred to as copy original).

The image-data storing unit 9 saves print data to be printed, scanning data of a copy original scanned by the original scanning unit 8. The image-data storing unit 9 is, for example, an HDD (Hard Disk Drive).

The liquid-crystal display unit 10 displays, for example, operation screens for a printing operation or a copying operation for print data. The operation screens have operation buttons for the number of prints or copies, adjustment of an image quality, adjustment of density, and the like. The liquid-crystal display unit 10 displays an indication that the print data to be printed, the scanning data of the copy original scanned by the original scanning unit 8, and the like are saved in the image-data storing unit 9.

The recording unit 11 prints the print data, the scanning data of the copy original, or the like saved in the image-data storing unit 9 on a recording medium 14. The recording unit 11 overlay-prints a user ID number and date information added to the print data or the scanning data of the copy original on the recording medium 14 in a void.

A personal computer (PC) 16 of a client is connected to the LAN control unit 12 via a LAN 15. The client PC 16 issues, for example, a command for starting the digital multiple apparatus main body 1 to the digital multiple apparatus main body 1 and transmits print data to be printed to the digital multiple apparatus main body 1. The LAN control unit 12 receives the start command and the print data, which are transmitted from the client PC 16, through the LAN 15 and passes the start command and the print data to the CPU 2.

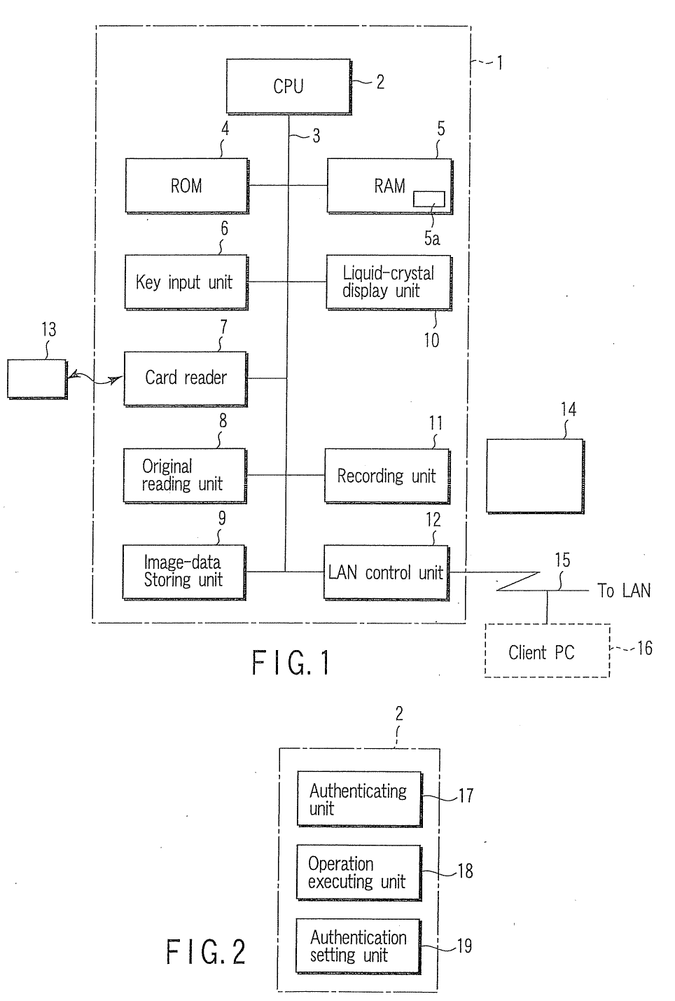

The CPU 2 executes the digital multiple operation program stored in the ROM 4. The CPU 2 has functions of a functional block diagram shown in FIG. 2 by executing the digital multiple operation program. The CPU 2 has an authenticating unit 17, an operation executing unit 18, and an authentication setting unit 19.

The authenticating unit 17 authenticates whether a user ID number read by the card reader 7 is a regular user ID number registered in the database for authentication 5a.

If the user ID number read by the card reader 7 is the regular user ID number as a result of the authentication by the authenticating unit 17, the operation executing unit 18 permits a printing operation by the recording unit 11 and prints the print data saved in the image-data storing unit 9 on the recording medium 14 using the recording unit 11 with information on at least the user ID number and date and time information of printing added to the print data.

If the user ID number read by the card reader 7 is the regular user ID number as a result of the authentication by the authenticating unit 17, the operation executing unit 18 permits a copying operation by the original scanning unit 8 and the recording unit 11 and performs the copying operation by the original scanning unit 8 and the recording unit 11 with information on at least the user ID number and date and time information of copying added to print data.

When the digital multiple apparatus main body 1 starts, the operation executing unit 18 reads a user ID number registered in the ID card 13 using the card reader 7.

When it is authenticated by the authenticating unit 17 that the user ID number is the regular user ID number, the operation executing unit 18 starts the copying operation by the original scanning unit 8 and the recording unit 11.

The operation executing unit 18 creates image data to be printed on the recording medium 14 with information on at least the user ID number and date and time information of printing overlaid thereon.

The operation executing unit 18 creates image data to be copied on the recording medium 14 with information on at least the user ID number and date and time information of copying overlaid thereon.

The operation executing unit 18 controls the recording unit 11 to print the information on at least the user ID number at the time of printing and the date and time information of printing and the information on at least the user ID number at the time of copying and the date and time information of copying in separate areas on the recording medium 14, respectively.

The authentication setting unit 19 sets an authenticating operation by the authenticating unit 17 in an ON state or an OFF state. When setting for making an overlay printing operation by the recording unit 11 effective is performed, the authentication setting unit 19 sets the authenticating operation by the authenticating unit 17 in the ON state.

The CPU 2 counts, for example, a reference clock and acquires date information from a value of this counting.

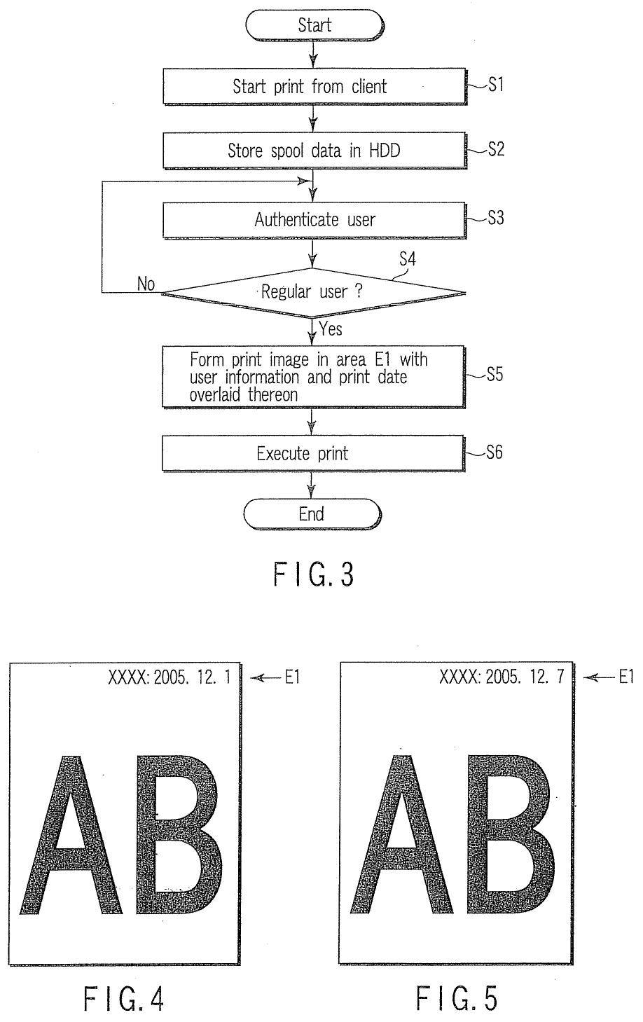

A user authenticating operation at the time of printing by the digital multiple apparatus constituted as described above will be explained in accordance with a digital multiple operation flowchart shown in FIG. 3.

The client PC 16 issues, for example, a command for starting the digital multiple apparatus main body 1 to the digital multiple apparatus main body 1 and transmits print data to be printed to the digital multiple apparatus main body 1. The start command and the print data are transmitted to the LAN control unit 12 through the LAN 15. The LAN control unit 12 receives the start command and the print data, which are transmitted from the client PC 16, through the LAN 15 and passes the start command and the print data to the CPU 2.

In step S1, the operation executing unit 18 of the CPU 2 receives the start command from the client PC 16 and starts the digital multiple apparatus main body 1.

In step S2, the operation executing unit 18 receives the print data (spool data) from the client PC 16 and saves this print data in the image-data storing unit 9.

Subsequently, a user brings the ID card 13 carried by the user close to the card reader 7. A user ID number given to the user is registered in the ID card 13. The card reader 7 reads, for example, the user ID number given to the user, which is registered in the ID card 13. The user ID number read is temporarily stored in, for example, the RAM 5.

In step S3, the authenticating unit 17 reads the user ID number temporarily stored in the RAM 5. At the same time, the authenticating unit 17 reads a regular user ID number registered in, for example, the database for authentication 5a. The authenticating unit 17 compares the user ID number read by the card reader 7 and the regular user ID number read from the database for authentication 5a and authenticates whether the user ID number read is the regular user ID number.

If the user ID number read is the regular user ID number as a result of the authentication, the operation executing unit 18 shifts from step S4 to step S5 and permits a printing operation by the recording unit 11.

In step S5, the operation executing unit 18 reads out the print data saved in the image-data storing unit 9 and reads the user ID number stored in the RAM 5. In this case, the CPU 2 has counted, for example, a reference clock and acquired date information from a value of this counting. Consequently, the operation executing unit 18 creates image data with the user ID number and date and time information of printing added to the print data. The operation executing unit 18 sends the image data to the recording unit 11.

In step S6, the recording unit 11 receives image data from the authenticating unit 17 and prints this image data on the recording medium 14. FIG. 4 shows an example of the print data printed on the recording medium 14, for example, “AB” and a user ID number “XXXX” and date and time information of printing “2005.12.1” added to this print data “AB”. The user ID number “XXXX” and the date and time information of printing “2005.12.1” are printed in, for example, an area E1 at the upper right on the recording medium 14.

The recording unit 11 overlay-prints the user ID number “XXXX” and the date and time information of printing “2005.12.1”. Consequently, in printing the print data “AB” at date and time different from the date and time “2005.12.1”, for example, date and time “2005.12.7”, the recording unit 11 creates image data with the user ID number “XXXX” and the date and time information of printing “2005.12.7” added to the print data “AB”.

Consequently, the user ID number “XXXX” and the date and time information of printing “2005.12.7” are overlay-printed in, for example, the area E1 at the upper right on the recording medium 14. FIG. 5 shows an example of the print data and the user ID number “XXXX” and the date and time information of printing “2005.12.7” printed on the recording medium 14.

Before printing the image data on the recording medium 14, adjustment of the number of sheets, an image quality, and density of print data to be printed, a size of the recording medium 14, and the like may be enabled. In other words, before printing the image data on the recording medium 14, the recording unit 11 reads out the print data saved in the image-data storing unit 9 and displays the print data on the liquid-crystal display unit 10. At the same time, the recording unit 11 displays a screen for print adjustment of the number of sheets, the image quality, and the density for printing the print data, the size of the recording medium 14, and the like on the liquid-crystal display unit 10. Consequently, the user becomes capable of adjusting the number of sheets, the image quality, and the density of the print data to be printed, the size of the recording medium 14, and the like.

If the user ID number read is not the regular user ID number, the operation executing unit 18 shifts from step S4 to step S5 and stands by for authentication of a user ID number read by the card reader 7 and the regular user ID number to be performed again.

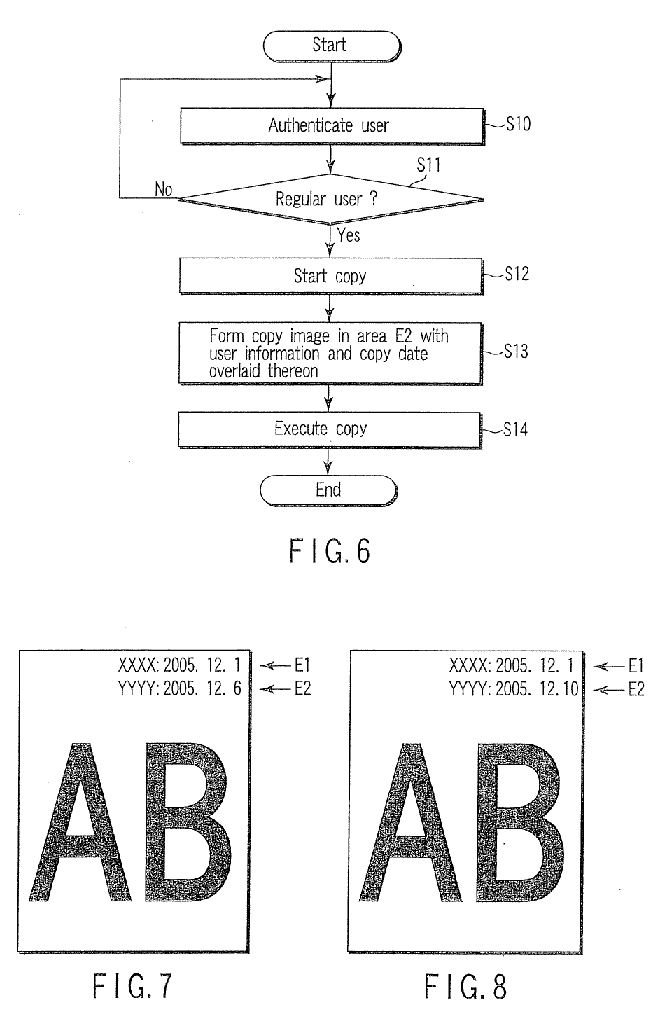

A user authenticating operation at the time of copying will be explained in accordance with a digital multiple operation flowchart shown in FIG. 6.

The user brings the ID card 13 carried by the user close to the card reader 7. The user ID number given to the user is registered in the ID card 13. The card reader 7 reads, for example, the user ID number given to the user, which is registered in the ID card 13. The user ID number read is temporarily stored in, for example, the RAM 5.

In step S10, the authenticating unit 17 reads the user ID number temporarily stored in the RAM 5. At the same time, the authenticating unit 17 reads, for example, the regular user ID number registered in the database for authentication 5a. The authenticating unit 17 compares the user ID number read by the card reader 7 and the regular user ID number read from the database for authentication 5a and authenticates whether the user ID number read is the regular user ID number.

If the user ID number read is the regular user ID number as a result of the authentication, the operation executing unit 18 shifts from step S11 to step S12 and permits a copying operation by the original scanning unit 8 and the recording unit 11.

The original scanning unit 8 scans an original to be copied in which characters such as letters and images are recorded. The original reading unit 8 outputs scanning data of the scanned original to be copied. This scanning data is saved in the image-data storing unit 9.

In step S13, the operation executing unit 18 reads out the scanning data of the original to be copied, which is saved in the image-data storing unit 9, and reads the user ID number stored in the RAM 5. In this case, the CPU 2 counts, for example, a reference clock and acquires date information from a value of this counting. Consequently, the operation executing unit 18 creates image data with the user ID number and date and time information of copying added to the scanning data. The operation executing unit 18 sends the image data to the recording unit 11.

In step S14, the recording unit 11 receives the scanning data from the operation executing unit 18 and copies this scanning data onto the recording medium 14. FIG. 7 shows the scanning data copied on the recording medium 14, for example, “AB” and a user ID number “XXXX” and date and time information of copying “2005.12.6” added to this print data “AB”.

A result of copying shown in FIG. 7 indicates an example in which the result of printing shown in FIG. 4 as the original to be copied is copied. The user ID number “XXXX” and the date and time information of copying “2005.12.6” are printed in, for example, an area E2 at the upper right on the recording medium 14 and right below the area E1 for printing of the user ID number “XXXX” and the date and time information of printing “2005.12.1”. The user ID number “XXXX” and the date and time information of copying “2005.12.6” are printed side by side with the user ID number “XXXX” and the date and time information of printing “2005.12.1”.

The recording unit 11 overlay-prints the user ID number “XXXX” and the date and time information of copying “2005.12.6”. Consequently, in copying the print data “AB” at a date and time different from the date and time “2005.12.6”, for example, a date and time “2005.12.10”, the recording unit 11 creates image data with the user ID number “XXXX” and the date and time information of copying “2005.12.10” added to the print data “AB”. Consequently, the user ID number “XXXX” and the date and time information of printing “2005.12.10” are overlay-printed in, for example, the area at the upper right on the recording medium 14. FIG. 8 shows an example of the print data and the user ID number “XXXX” and the date and time information of printing “2005.12.10” printed on the recording medium 14.

Before copying the print data, adjustment of the number of sheets, an image quality, and density of the print data to be copied, a size of the recording medium 14, and the like may be enabled. In other words, the recording unit 11 reads out the scanning data saved in the image-data storing unit 9 and displays the scanning data on the liquid-crystal display unit 10. At the same time, the recording unit 11 displays a screen for print adjustment of a number of sheets, an image quality, and density of for copying the scanning data, a size of the recording medium 14, and the like on the liquid-crystal displaying unit 10. Consequently, the user becomes capable of adjusting the number of sheets, the image quality, and the density of the print data to be copied, the size of the recording medium 14, and the like.

If the user ID number read is not the regular user ID number, the operation executing unit 18 shifts from step S11 to step S10 and stands by for authentication of a user ID number read by the card reader 7 and the regular user ID number to be performed again.

In this way, according to the embodiment, when the digital multiple apparatus main body 1 starts, a user ID number is read, it is authenticated whether the user ID number is a regular user ID number, a printing operation is permitted if the user ID number is the regular user ID number, and print data is printed with information on at least the user ID number and date and time information of printing added to the print data. In copying the print data, the user ID number is read, it is authenticated whether the user ID number is the regular user ID number, a copying operation is permitted if the user ID number is the regular user ID number, and scanning data at the time when the print data is copied is copied with information on at least the user ID number and date and time information of copying added to the scanning data.

Consequently, it is possible to easily identify a user who printed the print data and printing date and time and a user who copied the print data and copying date and time. Since the user of at least one of printing and copying and at least one of the printing date and time and the copying date and time are recognized from a paper document of the recording medium 14 on which the print data is printed or the recording medium 14 on which the print data is copied, it is possible to prevent information from leaking from the paper document.

Since the user who printed or copied the print data and the printing date and time or the copying date and time are overlay-printed in a void, it is possible to print a latest user who printed or copied the print data and a latest printing date and time or copying date and time on the recording medium 14. Since overlay-printing is performed, it is possible to print a latest printing date and time or copying date and time in the case that the same original to be copied is copied more than once on each of the different dates and times.

A user ID number and date and time information at the time of printing are printed in the area E1. A user ID number and date and time information at the time of copying are printed in the area E2 different from the area E1. Consequently, it is possible to identify a user who printed the print data and date and time information of the printing. It is possible to identify a user who copied the print data and a date and time of the copying. When both printing and copying were performed, it is possible to recognize users who performed the printing and the copying and date and times of the printing and the copying.

It is possible to set the authenticating operation by the authenticating unit 17 in the ON state or the OFF state. When setting for making the overlay printing operation by the recording unit 11 effective is performed, the authentication setting unit 19 sets the authenticating operation by the authenticating unit 17 in the ON state. A condition for setting the authenticating operation by the authenticating unit 17 in the ON state is not limited to a condition for setting the overlay printing operation effective. The authenticating operation may be set in the ON state when other operations are effective, for example, when the card reader 7 is set in an operation state or when the original scanning unit 8 is set in the operation state.

The invention is not limited to the embodiment described above and may be changed as described below.

Although a user ID number is read by the card reader 7, a user ID number may be key-inputted from, for example, the key input unit 6.

A user ID number and date and time information at the time of printing are not only printed in the area E1. A user ID number and date and time information at the time of copying are not only printed in the area. E2. The user ID numbers and the date and time information may be printed at, for example, any one of the four corners of the recording medium 14, for example, the upper left, the lower left, or the lower right.

Not only the user ID numbers are printed on the recording medium 14 and numbers, codes, and the like related to users may be printed on the recording medium 14.

The user ID number and the date and time information at the time of printing are not only printed in the area E1. The user ID number and the date and time information at the time of copying may be stored in, for example, the RAM 5 one after another as history data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital multiple apparatus comprising:
a recording unit configured to print data;
an authentication-data reading unit configured to read authentication data;
an authenticating unit configured to authenticate whether the authentication data read by the authentication-data reading unit is regular authentication data; and
an operation executing unit configured to permit the printing operation by the recording unit if the authentication data read by the authentication-data reading unit is the regular authentication data as a result of the authentication by the authenticating unit and print the print data using the recording unit with information on at least the authentication data and date and time information of printing added to the print data.

2. A digital multiple apparatus comprising:
a copying unit configured to perform copying;
an authentication-data reading unit configured to read authentication data;
an authenticating unit configured to authenticate whether the authentication data read by the authentication-data reading unit is regular authentication data; and
an operation executing unit configured to permit the copying operation by the copying unit if the authentication data read by the authentication-data reading unit is the regular authentication data as a result of the authentication by the authenticating unit and perform copying by the copying unit with information on at least the authentication data and date and time information of the copying added to print data.

3. A digital multiple apparatus according to claim 1, comprising a copying unit configured to perform copying, wherein
the operation executing unit permits the copying operation by the copying unit if the authentication data read by the authentication-data reading unit is the regular authentication data as a result of the authentication by the authenticating unit and performs copying by the copying unit with information on at least the authentication data and date and time information of the copying added to the print data.

4. A digital multiple apparatus according to claim 1, 2, or 3, wherein the authentication data includes user information.

5. A digital multiple apparatus according to claim 1 or 3, wherein the authentication-data reading unit reads the authentication data when a digital multiple apparatus main body starts.

6. A digital multiple apparatus according to claim 2 or 3, wherein the copying unit starts when it is authenticated by the authenticating unit that the authentication data is regular authentication data.

7. A digital multiple apparatus according to claim 1 or 3, wherein the operation executing unit forms the image to be printed with the information on at least the authentication data and the date and time information of the printing overlaid on the image.

8. A digital multiple apparatus according to claim 2 or 3, wherein the operation executing unit forms the image to be copied with the information on at least the authentication data and the date and time information of the copying overlaid on the image.

9. A digital multiple apparatus according to claim 3, wherein the operation executing unit forms, as images, the information on at least the authentication data and the date and time information of the printing at the time of the printing and the information on at least the authentication data and the date and time information of the printing at the time of copying in different areas, respectively.

10. A digital multiple apparatus according to claim 1, 2, or 3, comprising:
an authentication card that stores the authentication data; and
a key input unit configured to key-input the authentication data, wherein
the authentication-data reading unit reads the authentication data stored in the authentication card or reads the authentication data key-inputted from the key input unit.

11. A digital multiple apparatus according to claim 1, 2, or 3, comprising an authentication setting unit configured to set an authenticating operation by the authenticating unit in an ON state.

12. A digital multiple apparatus according to claim 11, wherein
the recording unit overlay-prints the information on at least the authentication data, the date and time information of the printing, and the date and time information of the copying, and
the authentication setting unit sets the authenticating operation by the authenticating unit in an ON state when a state of the overlay printing is effective.

13. A storage medium having stored therein an authentication program for a digital multiple apparatus comprising:
reading authentication data when a digital multiple apparatus main body starts and authenticating whether the authentication data read is regular authentication data; and
permitting a printing operation if the authentication data read is the regular authentication data as a result of the authentication and printing print data with information on at least the authentication data and date and time information of printing added to the print data.

14. A storage medium having stored therein an authentication program for a digital multiple apparatus comprising:
reading authentication data and authenticating whether the authentication data read is regular authentication data; and
permitting a copying operation if the authentication data read is the regular authentication data as a result of the authentication and performing the copying operation with information on at least the authentication data and date and time information of the copying added to print data.

15. A storage medium having stored therein an authentication program for a digital multiple apparatus according to claim 13, wherein a copying operation is permitted if the authentication data read is the regular authentication data as a result of the authentication and the copying operation is performed with the information on at least the authentication data and the date and time information of the copying added to the print data.
